(19) United States
(12) Patent Application Publication
(10) Pub. No.: US 2016/0191371 A1
(43) Pub. Date: Jun. 30, 2016

(54) Automatically Configuring A Virtual Router

(71) Applicants: Yogesh Banwarilal DUJODWALA, Bangalore, Kamataka (IN); Adarsh PARNA, Kamataka, Bangalore (IN); HEWLETT-PACKARD DEVELOPMENT COMPANY, L.P., Houston, TX (US)

(72) Inventors: Yogesh Banwarilal Dujodwala, Bangalore (IN); Adarsh Supama, Bangalore (IN)

(21) Appl. No.: 14/909,638

(22) PCT Filed: Aug. 29, 2013
(86) PCT No.: PCT/IN2013/000528

§ 371 Date: Feb. 2, 2016

(51) Int. Cl. H04L 12/751; H04L 12/931; H04L 29/08; H04L 12/66; H04L 12/46; H04L 12/713; H04L 12/24

(52) U.S. Cl. CPC H04L 45/02; H04L 45/586; H04L 49/70; H04L 41/0846; H04L 12/66; H04L 12/4641; H04L 67/10

(57) ABSTRACT

Provided is a method of automatically configuring a virtual router. Upon addition of a new virtual network switch to a host computing system on a network, a network or subnet of the virtual network switch is determined. If the network or subnet is not present in the routing table of a virtual router on the network, routing information related to the virtual network switch is added to the routing table of the virtual router.

### BACKGROUND

Computer networks have become increasingly important as enterprises look for agility to cope with dynamic business environments. One of the technologies that have helped companies adapt to ever changing computing needs of its customers is virtualization. Virtualization allows creation of a virtual resource such as a hardware platform, storage resource, a network interface card, etc. which could be shared among different virtual machines, for instance, through a virtual network. A virtual network is a computer network that functions through virtual resources rather than physical resources.

### BRIEF DESCRIPTION OF THE DRAWINGS

For a better understanding of the solution, embodiments will now be described, purely by way of example, with reference to the accompanying drawings, in which:

FIG. 1 illustrates a system for automatically configuring a virtual router, according to an example.

FIG. 2 shows a flow chart of a method of automatically configuring a virtual router, according to an example.

FIG. 3 shows a flow chart of a method of automatically configuring a virtual router, according to an example.

### DETAILED DESCRIPTION OF THE INVENTION

An enterprise may grow and expand to different geographical locations over a period of time or it may develop business associations with other organizations situated in different parts of the world. An organization's computer network is expected to keep pace with its expansion by providing timely applications and services to its management, employees, clients, vendors, partners, etc. In other words, computer networks need to be adaptive to the needs of a business.

Virtual networks provide the agility that an enterprise requires to compete in a dynamic environment. Virtual networks offer a number of benefits over physical computer networks. These benefits could include, for example, network scalability and flexibility, cost savings, ease of deployment and use, enhanced security, remote control, improved network performance and efficiency, etc. Thus, not surprisingly, organizations are gradually deploying an increasing number of virtual resources (such as virtual machines, virtual switches, etc.) in their networks to support a variety of applications and services.

Although virtual networks provide much needed flexibility to enterprises by offering on-demand deployment of virtual network resources, it may lead to router configuration issues if virtual network switches are created (or removed) on-demand by various users of a network. It would require a manual configuration of a virtual router(s) to route traffic between newly created network switches on a network since there is no mechanism to configure a virtual router automatically. It is a manual process which is time consuming, error prone and repetitive. The issue becomes further compounded if there are multiple hosts, multiple virtual switches on hosts and multiple routers between hosts. A user (for example, a network administrator) would be required to configure the routers manually on all hosts. Needless to say, as a network grows in complexity, it becomes unmanageable to configure virtual routers manually.

Proposed is a solution for automatically configuring a virtual router. In an example, upon addition of a new virtual network switch to a host machine on a network, the network or subnet of the virtual network switch is determined. If the network or subnet is not present in the routing table of a virtual router, the routing information related to the virtual network switch is added to the routing table of the virtual router. The process is performed for each virtual switch added to a host machine on a computer network. In an example, the aforesaid network is a private cloud.

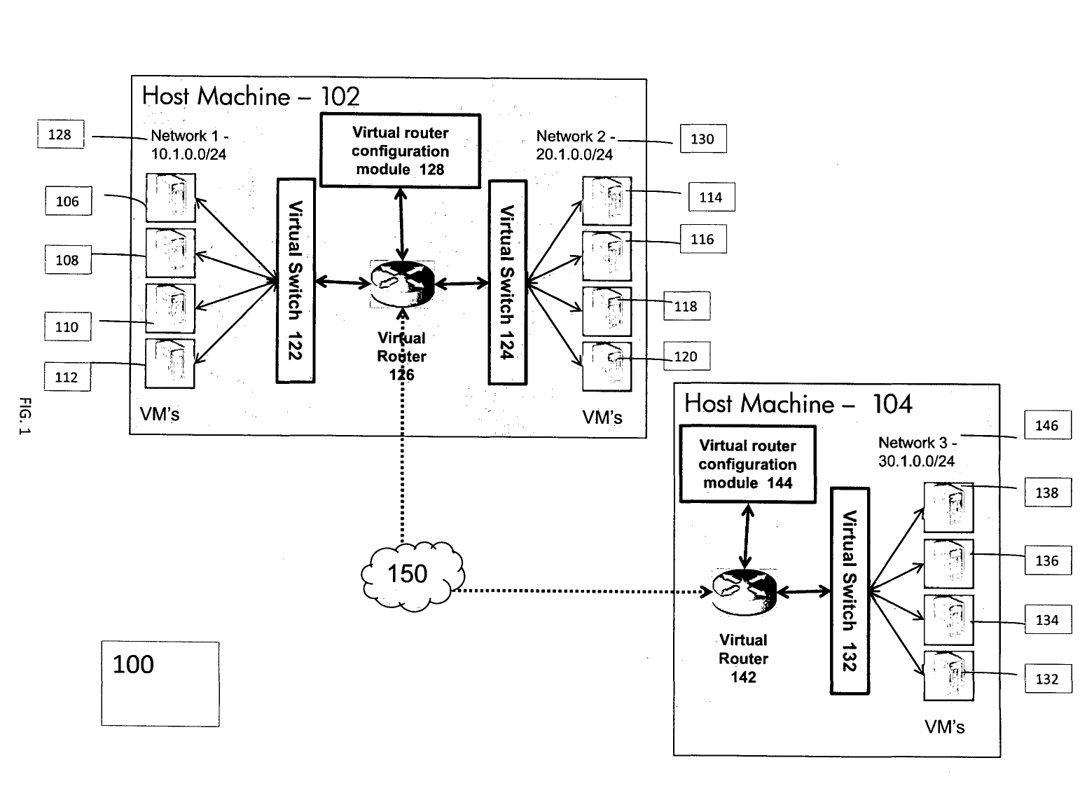

FIG. 1 illustrates a system 100 for automatically configuring a virtual router, according to an example. System 100 includes host computing systems 102 and 104, which may be operationally coupled over a computer network 150.

Host computing systems 102 and 104 may be, for example, a computer server, desktop computer, notebook computer, tablet computer, mobile phone, personal digital assistant (PDA), or the like. Host computing systems 102 and 104 may include a processor for executing machine readable instructions and a memory (storage medium) for storing machine readable instructions. In an example, host computing systems 102 and 104 are under the control and management of different users.

Host computing system 102 includes virtual machines (VMs) 106, 108, 110, 112, 114, 116, 118, and 120, virtual switches 122 and 124, virtual router 126, and virtual router configuration module 128. Host computing system 104 includes virtual machines (VMs) 132, 134, 136, and 138, virtual switch 140, virtual router 142, and virtual router configuration module 144. Virtual machines (VMs) 106, 108, 110, 112, 114, 116, 118, 120, 132, 134, 136, and 138 may be created on host computing systems 102 and 104.

Virtual machines (VMs) 106, 108, 110, and 112 are connected to virtual switch 122 to form virtual network 128 (Network 1—10.1.0.0/24), virtual machines (VMs) 114, 116, 118, and 120 are connected to virtual switch 124 to form virtual network 130 (Network 2—20.1.0.0/24), and virtual machines (VMs) 132, 134, 136, and 138 are connected to virtual switch 140 to form virtual network 146 (Network 3—30.1.0.0/24). Virtual switches 122, 124 and 140 allow one virtual machine to communicate with another. In the present example, virtual switch 122 allows virtual machines (VMs) 106, 108, 110, and 112 to communicate with each other i.e. within virtual network 128 (Network 1—10.1.0.0/24). Similarly, virtual switch 124 allows virtual machines (VMs) 114, 116, 118, and 120 to communicate with each other i.e. within virtual network 130 (Network 2—20.1.0.0/24). Virtual switch 140 allows virtual machines (VMs) 132, 134, 136, and 138 to communicate with each other i.e. within virtual network 146 (Network 3—30.1.0.0/24).

Virtual routers 126 and 142 join different networks together and allow computing systems across different networks to communicate with each other. Virtual routers 126 and 142 can be created on a hypervisor (of a host machine) and may include various routing protocols to route traffic across networks which are created using virtual switches. For instance, virtual router 126 may route traffic between virtual machines (VMs) 106, 108, 110, 112, 114, 116, 118, and 120, across virtual networks 128 (Network 1—10.1.0.0/24) and 130 (Network 2—20.1.0.0/24) through virtual network switches 122 and 124. Virtual routers 126 and 142 may route traffic between virtual machines (VMs) on host computing systems 102 and 104 across virtual networks 128 (Network 1—10.1.0.0/24), 130 (Network 2—20.1.0.0/24), and 146 (Network 3—30.1.0.0/24). In an example, virtual routers 126 and 142 are kernel network module of the virtualization layer which acts as a layer 3 router.

Computer network 150 may be a wired (for example, a coaxial cable) or wireless (for example, Wi-Fi) network. In an implementation, computer network 150 is the Internet. However, in other implementations it may be an intranet, a local area network (LAN), wide area network (WAN), or the like.

Virtual router configuration modules 128 and 144 act on virtual routers 126 and 142 respectively. In an implementation, a virtual router configuration module (such as 128 and 144) determines, upon addition of a new virtual network switch to a host computing system on a network, a network or subnet of the virtual network switch and whether the network or subnet is present in a routing table of the virtual router. If the network or subnet is not present in the routing table of the virtual router, virtual server module adds routing information related to the virtual network switch subnet to the routing table of the virtual router. In an example, a virtual router configuration module (such as 128 and 144) operates on a hypervisor on a host computing system.

Virtual router configuration modules 128 and 144 may be implemented in the form of a computer program product including computer-executable instructions, such as program code, which may be run on any suitable computing environment in conjunction with a suitable operating system, such as Microsoft Windows, Linux or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. In an implementation, virtual router configuration modules 128 and 144 may be read into a device memory from another computer-readable medium, such as data storage device, or from another device via a communication interface.

For the sake of clarity, the term “module”, as used in this document, may mean to include a software component, a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. The module may reside on a volatile or non-volatile storage medium and configured to interact with a processor of a computer system. Further, system 100 may include additional client computer systems, computer servers, and other devices.

It would be appreciated that the system components depicted in FIG. 1 are for the purpose of illustration only and the actual components may vary depending on the computing system and architecture deployed for implementation of the present solution. The various components described above may be hosted on a single computing system or multiple computer systems, including servers, connected together through suitable means.

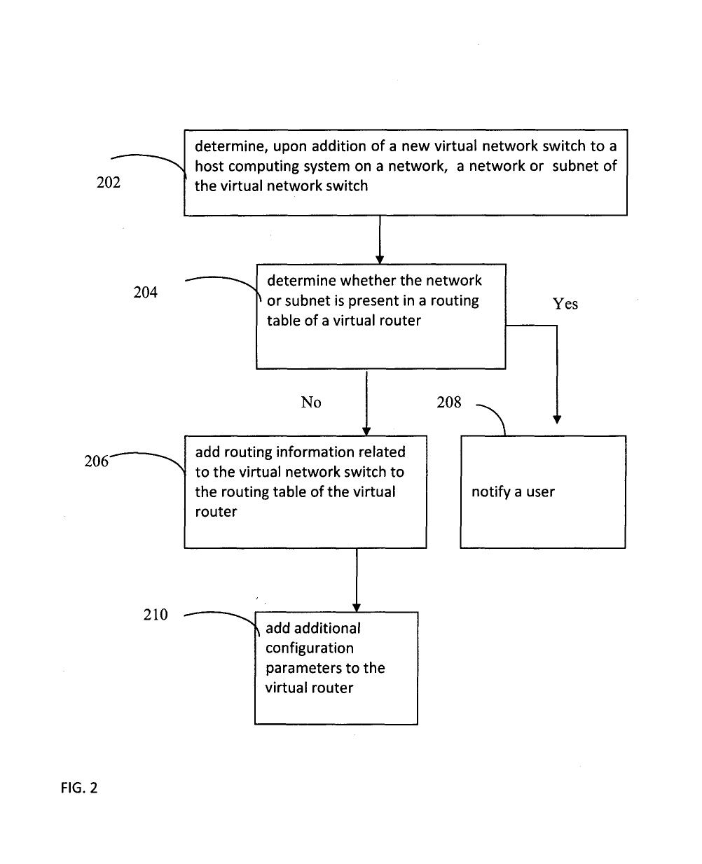

FIG. 2 shows a flow chart of a method of automatically configuring a virtual router, according to an example.

At block 202, upon addition of a new virtual network switch to a host computing system on a computer network, the network and/or subnet to which the new virtual network switch has been added is determined. In other words, once a user creates a new virtual network switch on a network, the network and/or subnet address of the new virtual switch is ascertained. In an implementation, aforesaid determination is performed by a virtual router configuration module on the host machine on which a new virtual switch has been created. The virtual router configuration module may enable a routing protocol daemon on the host computing system, for instance, to obtain neighboring information i.e. information regarding neighbor network devices. A routing protocol daemon maintains a routing table on a device and each routing protocol (such as Open Shortest Path First (OSPF), Routing Information Protocol (RIP), Border Gateway Protocol (BGP)) provides its own daemon. A routing protocol daemon communicates with daemons on other devices on a network to obtain and exchange routing information such as network topology information with other routers. In the present context, based on information gathered from a routing protocol daemon(s), virtual router configuration module adds a virtual switch interface of the newly created virtual network switch to a virtual router on the host computing system. In another implementation, if a Virtual Local Area Network (VLAN) is configured on a newly created virtual switch, virtual router configuration module adds the VLAN to a virtual router on the host computing system.

Computer network that includes the host computing system may be a physical network, a virtual network, or a combination thereof.

At block 204, a determination is made whether the determined network or subnet of a newly created virtual network switch is present in a routing table of a virtual router on a host computing system. Said differently, a routing table of a virtual router on the host computing system is checked to determine whether the network and/or subnet address of a newly added virtual switch exits. In an implementation, aforesaid determination is performed by a virtual router configuration module on a host machine on the network.

At block 206, if it is determined that the network or subnet of a newly created virtual network switch is not present in a routing table of a virtual router on a host computing system, routing information related to the newly created virtual network switch is added to the routing table of the virtual router. In an implementation, aforesaid determination is performed by a virtual router configuration module on a host machine on the network.

In the event, if it is determined that the network or subnet of a newly created virtual network switch already exists in a routing table of a virtual router on a host computing system, routing information related to the newly created virtual network switch is ignored. In other words, routing information is not included in a routing table of the virtual router (block 208). In an example, a user is notified regarding such existence. In another example, if it is determined that the network or subnet of a newly created virtual network switch is incorrect; the user is notified regarding such error. In an implementation, aforementioned determination and notification is performed by a virtual router configuration module on a host machine on the network.

At block 210, the virtual router may be configured with configuration parameters of a newly created virtual network switch, the default gateway, a Virtual Local Area Network (VLAN) configuration (if a VLAN is configured on the newly created virtual switch), VLAN subnets, etc. Upon configuration, the virtual router enables routing to a VLAN configured on a newly created virtual switch.

In an implementation, network topology of the computer network that includes the host computing system is also updated on the virtual router. In another implementation, an access list may also be configured on the virtual router.

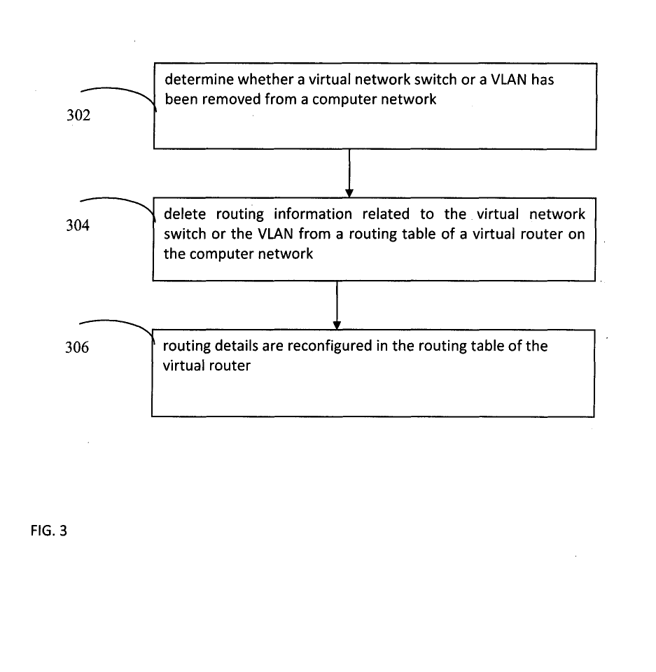

FIG. 3 shows a flow chart of a method of automatically configuring a virtual router, according to an example.

At block 302, a determination is made whether a virtual network switch or a VLAN has been removed from a computer network. Computer network may be a physical network, a virtual network, or a combination thereof.

At block 304, if it is determined that a virtual network switch or a VLAN has been removed from a computer network, the routing information related to the virtual network switch or the VLAN is removed from a routing table of a virtual router on the computer network.

At block 306, upon removal of the routing information related to a virtual network switch or a VLAN from a routing table of a virtual router, routing details on the whole are reconfigured in the routing table of the virtual router.

In an implementation, the aforementioned acts (blocks 302 to 304) may be performed by a virtual router configuration module on a host machine on the computer network.

It will be appreciated that the embodiments within the scope of the present solution may be implemented in the form of a computer program product including computer-executable instructions, such as program code, which may be run on any suitable computing environment in conjunction with a suitable operating system, such as MICROSOFT WINDOWS, LINUX or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present solution is for the purpose of illustration only. Although the solution has been described in conjunction with a specific embodiment thereof, numerous modifications are possible without materially departing from the teachings and advantages of the subject matter described herein. Other substitutions, modifications and changes may be made without departing from the spirit of the present solution.

We claim:

1. A method of automatically configuring a virtual router, comprising:
determining, upon addition of a new virtual network switch to a host computing system on a network, a network or subnet of the virtual network switch;
determining whether the network or subnet is present in a routing table of the virtual router; and
adding routing information related to the virtual network switch to the routing table of the virtual router if the network or subnet is not present in the routing table of the virtual router.

2. The method of claim 1, further comprising notifying a user if the network or subnet is present in the routing table of the virtual router.

3. The method of claim 1, further comprising notifying a user if the network or subnet is incorrect.

4. The method of claim 1, further comprising configuring the virtual router with configuration parameters of the virtual network switch.

5. The method of claim 1, further comprising configuring the virtual router with configuration parameters of a default gateway.

6. The method of claim 1, further comprising configuring the virtual router with configuration parameters of a Virtual Local Area Network (VLAN) configured on the virtual switch.

7. The method of claim 6, further comprising enabling routing through the virtual router to the VLAN configured on the virtual switch.

8. The method of claim 1, further comprising configuring an access list on the virtual router.

9. The method of claim 1, further comprising updating network topology of the network on the virtual router.

10. A method of automatically configuring a virtual router, comprising:
deleting, upon removal of a virtual network switch or a VLAN from a network, the routing information related to the virtual network switch or the VLAN from a routing table of the virtual router; and
reconfiguring routing details on the routing table of the virtual router further to said deletion.

11. A system for automatically configuring a virtual router, comprising:
a virtual router configuration module; and
a virtual router, wherein upon addition of a new virtual network switch to a host computing system on a computer network, the virtual router configuration module determines a network or subnet of the virtual network switch, and adds routing information related to the virtual network switch to the routing table of the virtual router if the network or subnet is not present in the routing table of the virtual router.

12. The system of claim 12, wherein the virtual router configuration module operates on a hypervisor on the host computing system.

13. The system of claim 13, wherein the computer network is a virtual network.

14. The system of claim 13, wherein the computer network is a private cloud network.

15. A non-transitory processor readable medium, the non-transitory processor readable medium comprising machine executable instructions, the machine executable instructions when executed by a processor causes the processor to:
determine, upon addition of a new virtual network switch to a host computing system on a network, a network or subnet of the virtual network switch;
determine whether the network or subnet is present in a routing table of a virtual router; and
add routing information related to the virtual network switch to the routing table of the virtual router if the network or subnet is not present in the routing table of the virtual router.
